(19) United States
(12) Patent Application Publication
(10) Pub. No.: US 2012/0327081 A1
(43) Pub. Date: Dec. 27, 2012

(54) PERCUTANEOUS PUNCTURE SUPPORT SYSTEM

(76) Inventor: Yuji Suda, Sendai-shi (JP)

(21) Appl. No.: 13/578,849

(22) PCT Filed: Jan. 27, 2011
(86) PCT No.: PCT/JP2011/051588

§ 371 Date: Sep. 11, 2012

(30) Foreign Application Priority Data
Feb. 24, 2010 (JP) 2010-038504

(51) Int. Cl. G06T 17/00

(52) U.S. Cl. 345/419

(57) ABSTRACT

Percutaneous sampling examination of a chest lesion is performed by using a general-purpose X-ray CT apparatus and an X-ray TV fluoroscope.

An X-ray non-transmissive coordinate gauge is attached to a skin and then volumetric data of the patient are obtained by using the X-ray CT apparatus. A puncture route to the lesion is selected by analyzing the volumetric data, and the puncture route and the lesion are clearly written in the volumetric data. From this secondary volumetric data, a body surface is visualized, and the coordinates of a point of which the puncture route passes through the skin are read from the coordinate gauge, and the point (an insertion point) is marked on the skin of the patient.

From the insertion point a biopsy needle is inserted into the body while monitoring a composite image which is formed by superimposing the two images, namely a fluoroscopic image obtained from the X-ray TV fluoroscope and a virtual fluoroscopic image obtained by fluoroscopic conversion of secondary volumetric data from the same direction as the TV fluoroscope. If the biopsy needle displayed on the fluoroscopic image is on the puncture route on the virtual fluoroscopic image, it is found that the needle is in a correct position. When the body of the patient has carelessly moves during the examination, displacements of organs such as tracheas and lungs are caused between the fluoroscopic image and the virtual perspective image, and thus it is found that the body of the patient has moved.

### TECHNICAL FIELD

This invention relates to a system for supporting a manipulation of percutaneously inserting a biopsy needle to a lesion.

### BACKGROUND ART

As X-ray CT scanners have come into wider use something like a lesion is often found out in a human body. In such cases a sampling examination is needed to determine diagnosis. When the lesion is situated at a relatively shallow place, a percutaneous sampling method is normally employed, in which a biopsy needle is inserted through the skin so as to take the lesion tissue. To keep the biopsy needle in the right direction, it is normally used with a needle guide which is attached on patient skin. However, the needle can deviates from the lesion due to various causes. Accordingly, needle biopsy is normally inserted under CT-guide to confirm the needle position (see Patent Document below, for example). To project the position of the biopsy needle onto a monitor screen in almost real time, the CT scanner requires higher data processing performance and thus high cost. Furthermore, the examination under CT-guide has the disadvantage of exposing a patient high dose of radioactivity.

### PRIOR ART DOCUMENT

### Patent Document

Japanese Patent Application Laid-open No. 2004-283420

### SUMMARY OF THE INVENTION

### Problems To Be Solved By the Invention

This invention has an object to percutaneously guide a biopsy needle to a lesion by using an X-ray CT scanner and an X-ray TV fluoroscopic apparatus each being of a general-purpose type.

### Means For Solving the Problems

In the support system according to this invention, an X-ray non-transmitting coordinate gauge is attached on a skin near the lesion, and then volumetric data of a patient body is obtained by using an X-ray CT scanner. From the volumetric data, visible images are constructed. Using these images, a puncture route of a biopsy needle from the outside of a body to the lesion is determined. Both images of the puncture route and the lesion are clearly written in the original volumetric data, with the result that the secondary volumetric data is formed. From the secondary volumetric data, a visualized image of patient's body surface is generated, and the position of the point in which the puncture route passes through the skin are read from the image of the coordinate gauge, and then the point is marked on the actual skin of the patient.

Next, the secondary volumetric data is perspective transformed to form a virtual perspective image of the patient which is seen from a certain direction, and the image is superimposed on an X-ray fluoroscopic image of the patient that is taken from the same direction thereof. For exact superposing, some internal organ images are preferably written in the secondary volumetric data for use as a guiding mark.

In this manner, the biopsy needle is inserted from the insertion point previously marked on the skin, and is advanced to the lesion while checking that the image of the needle is on the puncture route on the composite image.

### BRIEF DESCRIPTION OF DRAWINGS

FIG. 1 is a processing flow diagram of a percutaneous puncture support system;

FIG. 2 is an explanatory view of a coordinate gauge;

FIG. 3 shows a cross-sectional image that is reconstructed from volumetric data and includes a lesion; and

FIG. 4 is a composite image of an X-ray fluoroscopic image and a virtual perspective image being superimposed each other.

### MODES FOR CARRYING OUT THE INVENTION

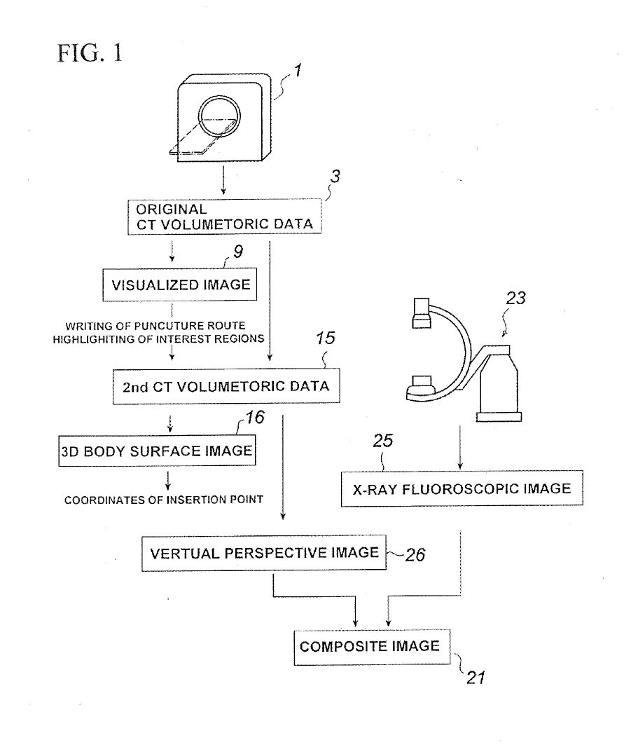

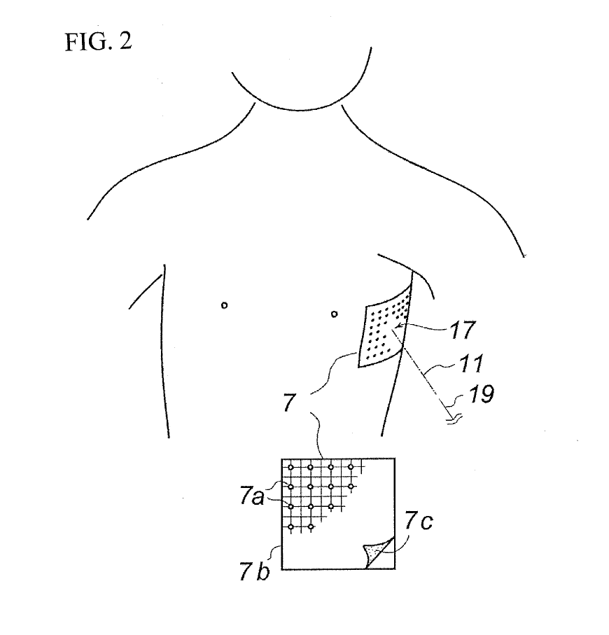

When something like a lesion is found out in a lung and a percutaneous sampling examination is performed, volumetric data 3 of a chest is obtained by using an X-ray CT scanner 1, as shown in FIG. 1. As the X-ray CT scanner, a general-purpose helical CT scanner can be used. Prior to the CT scanning, as shown in FIG. 2, an X-ray non-transmitting coordinate gauge 7 is stuck on a skin near a lesion 5, thus the gauge image is also taken in the volumetric data 3. The coordinate gauge 7 has a plurality of metal pieces 7a (of disc shape, for example) fixed crosswise at regular intervals on a sheet 7b, and is attached on the skin with an adhesive 7c on the back of the sheet 7b. The coordinate gauge 7 can be something like a wire mesh, which is fixed on the skin by an adhesive tape.

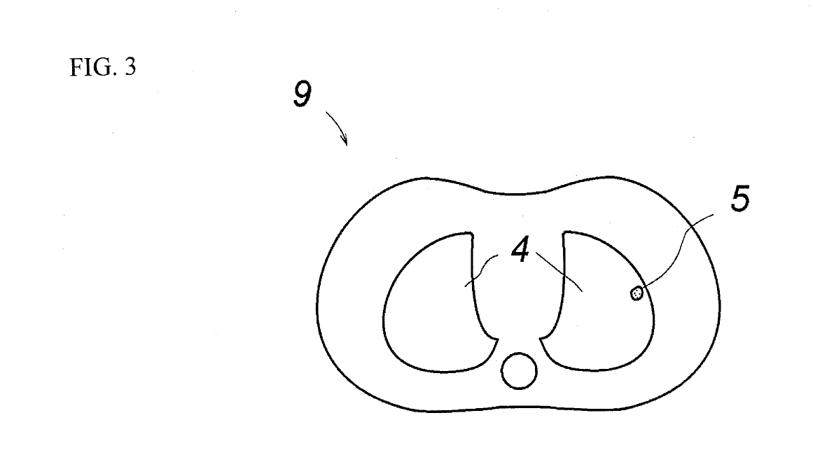

From the original volumetric data 3 obtained in this manner, visualized images 9 (for example, cross-sectional images or 3D images) are formed. FIG. 3 shows a cross-sectional image of the chest at right angle to the body axis, where the lesion 5 is shown under a pleura of a lung 4. By analyzing these visualized images 9, a linear puncture route 11 from the outside of the body to the lesion 5 is determined. The route should be kept away from ribs, blood vessels and other dangerous parts. The determined puncture route is written to the volumetric data 3 with a high HU value corresponding to metal so as to be clearly seen when visualized later.

Similarly, using the visualized images 9, both regions of the lesion 5 and peripheral internal organs 13 (for example, a lung apex 13a, a trachea lower and right and left bronchi 13b, a diaphragm 13c, and so on) on the volumetric data are specified. Then the data of the specified regions are transformed into high HU values equivalent to metal so as to become more noticeable when visualized thereafter.

From this secondary volumetric data 15, a 3D body surface image 16 is produced by means of a volumetric rendering method (FIG. 1). On the image 16, as indicated by a chain line in FIG. 2, the state where the puncture route 11 passes through the skin is shown, and thus coordinates of a point of which the puncture route 11 passes through the skin can be read from an image of the coordinate gauge 7. The point is marked on the actual skin of a patient according to the coordinate gauge 7 attached on the skin, and can be used as an insertion point 17 of a needle (FIG. 2).

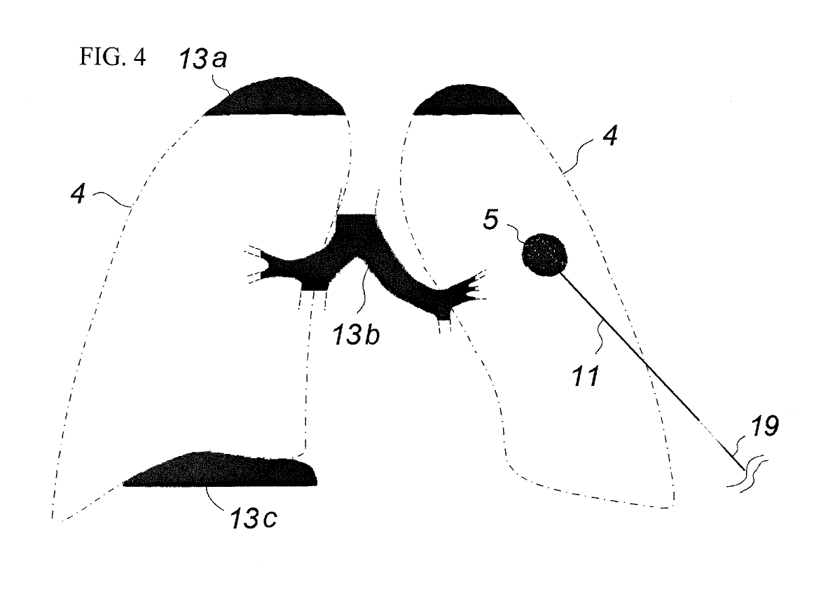

In order to push ahead a biopsy needle 19 from the insertion point 17 along the puncture route 11, a composite image 21 of two images being superimposed each other is displayed on a monitor screen (FIG. 1). The first one of two images is a chest fluoroscopic image 25 (a live image) of the patient obtained in a C-arm type X-ray TV fluoroscopic apparatus 23. The second image is a virtual perspective image 26 which is generated from the above-described secondary volumetric data 15 by using a perspective projection method. In FIG. 4 showing the composite image of the patient, the portions indicated by chain lines, that is, contours of the lungs 4, the trachea lower portion and right and left main bronchi 13b, are images from the TV fluoroscopic image 25. Portions other than the chain line are the virtual perspective image 26, where the lesion 5, the puncture route 11, and the marker organs 13 (the lung apex 13a, the trachea lower portion and right and left main bronchi 13b, and the diaphragm 13c) are shown.

It should be noticed here that the contours of the lungs 4 in the TV fluoroscopic image 25 are exactly overlapped with the lung apex 13a and the diaphragm 13c in the virtual perspective image 26, and no mismatch exists between the trachea lower portion and right and left main bronchi 13b in both images. In order for both the images to be overlaid exactly, the perspective direction in forming the virtual perspective image should be the same as that of the X-ray TV fluoroscopic apparatus 23; also it is important to make the perspective point coincident with that of the TV fluoroscopic apparatus. Further, when checking if the disagreement exists or not, it is important that the patient holds his/her breath at the same inhalation position as when the volumetric data was first obtained in the CT scanner, and then the TV fluoroscopic image is obtained.

On the secondary volumetric data 15, as described previously, each of the areas of the lesion 5, the puncture route 11, the organs 13 (the lung apex, the tracheas, the diaphragm, and so on) are transformed into the HU value corresponding to metal, so that these areas are shown in white on the monitor screen, (FIG. 4 is in reverse mode, they are shown in black). For this reason, in the overlaid portions, the X-ray TV fluoroscopic image 25 is masked completely and thus hard to see. Thus, it is preferable to make the density of the perspective image decrease a little before superimposing.

In a puncture process, the X-ray TV fluoroscopic apparatus needs to change the perspective direction several times in order to check if the needle 19 is on the puncture route 11 properly, and if the needle 19 has reached the lesion 5. Thus, every time the X-ray TV fluoroscopic apparatus changes its orientation, this system is designed to receive such change information, and automatically generate the virtual perspective image, corresponding to a posture at that moment, which is superposed on the fluoroscopic image.

At the beginning of a puncture procedure, the patient is kept steady on the bed, and seen through the X-ray TV fluoroscopic apparatus 23 to form the fluoroscopic image 25. Also the virtual perspective image with same view direction is generated from the secondary volumetric data, and is superimposed on said fluoroscopic image 25. Then it is confirmed that no displacements of the lung apex 13a, the trachea lower portion and main bronchi 13b, the diaphragm 13c, and so on are caused between the two images. Unless the patient moves his/her body from this initial state, no displacements are caused in the composite image 21. When the perspective direction of the TV fluoroscopic apparatus 23 is changed, the virtual perspective image 26 is automatically generated according to the perspective direction, thus no displacements are caused.

However, when the body of the patient has moved from the initial state thereafter, the puncture route 11 on the perspective image no longer indicates the correct position. Thus, during the procedure, it is important to always check that no displacements are caused between the TV fluoroscopic image 25 and the virtual perspective image 26, and when the displacements are found, the body of the patient is moved back to the initial position and the operation is performed again.

Before the biopsy needle 19 is inserted, the direction of the TV fluoroscopic apparatus 23 is adjusted to agree with the axis of the puncture route 11, so that the puncture route may be seen as one point on the monitor screen. Thus, the biopsy needle 19 is inserted from the insertion point 17, to and is advanced so that the needle 19 and the puncture route 11 may be overlapped with each other to be always seen as a dot on the monitor screen. When the direction of the needle deviates from the puncture route, the needle looks like a line (not a dot), and thus the deviation can be noticed.

When the needle tip approaches the lesion, the orientation of the TV fluoroscopic apparatus 23 is changed so that the puncture route 11 may be seen from the substantially perpendicular direction. Also in the this case, the virtual perspective image in the same direction as that of the TV fluoroscopic apparatus is automatically generated, so that while monitoring this composite image, it can be checked that the biopsy needle has reached the lesion, and then sampling of a lesion tissue is performed.

The biopsy needle is a conventional one, and has a spiral groove formed around the periphery of a tip portion thereof, and it is designed that when the needle is pulled out, the tissues are scraped off by an edge of the groove to be accumulated in the groove.

### EXPLANATION OF NUMERALS AND SYMBOLS

1 X-ray CT scanner

3 volumetric data (original)

4 lung

5 lesion

7 coordinate gauge

9 visualized image

11 puncture route

13 mark organ

15 volumetric data (secondary)

17 insertion point

19 biopsy needle

21 composite image

23 X-ray TV fluoroscopic apparatus

25 TV fluoroscopic image

26 virtual perspective image

1. A percutaneous puncture support system comprising:
a means for obtaining CT volumetric data of a test subject in a state where an X-ray-impermeable coordinate gauge is applied on the skin of the subject;
a means for determining a puncture route from the outside body to a lesion by using a visual image produced from said CT volumetric data, and writing the route in the volume data with a high HU value corresponding to metal to form CT secondary volume data;
a means for producing a three-dimensional body surface image from the CT secondary volume data, and reading a point of which the puncture route passes through the skin from the image of the coordinate gauge on said body surface image;
a means for perspective transforming the secondary volume data to form a virtual perspective image of the subject being seen from a certain direction; and
a means for superimposing said virtual perspective image and the X-ray fluoroscopic image of the subject that is taken from the same direction as that of said virtual perspective image to produce a composite image for display.

2. The percutaneous puncture support system according to claim 1, wherein said virtual perspective image includes images of organs of the test subject organs as marks for superimposing.
